(19) United States
(12) Patent Application Publication
(10) Pub. No.: US 2017/0076426 A1
(43) Pub. Date: Mar. 16, 2017

(54) DISPLAY DEVICE, DISPLAY SYSTEM, AND STORAGE MEDIUM

(71) Applicants: Aritaka Hagiwara, Kanagawa (JP); Kei Oyamada, Kanagawa (JP); Hidekuni Annaka, Saitama (JP); Tomoyuki Tsukuda, Kanagawa (JP); Ryo Iwasaki, Tokyo (JP)

(72) Inventors: Aritaka Hagiwara, Kanagawa (JP); Kei Oyamada, Kanagawa (JP); Hidekuni Annaka, Saitama (JP); Tomoyuki Tsukuda, Kanagawa (JP); Ryo Iwasaki, Tokyo (JP)

(73) Assignee: Ricoh Company, Ltd., Tokyo (JP)

(21) Appl. No.: 15/260,187

(22) Filed: Sep. 8, 2016

(30) Foreign Application Priority Data
Sep. 15, 2015 (JP) 2015181529

(51) Int. Cl. G06T 3/40; G06F 3/0488

(52) U.S. Cl. CPC G06T 3/40; G06F 3/04886; G06T 2207/20132

(57) ABSTRACT

A display device includes a receiver configured to receive a plurality of images from a plurality of terminal devices, respectively, a determiner configured to determine to crop at least one of the plurality of images, upon detecting that some or all of the plurality of images including the at least one of the plurality of images have more than a predetermined number of parts in common, a cropper configured to crop one of the plurality of images and configured to generate a new image based on a cropped part of the one of the plurality of images, and a display controller configured to adjust the size of the new image in accordance with a size of one of the plurality of divided display regions and configured to display the new image having the adjusted size on the one of the plurality of divided display regions.

### CROSS-REFERENCE TO RELATED APPLICATIONS

The present application claims the benefit of priority under 35 U.S.C. §119 of Japanese Patent Application No. 2015-181529, filed Sep. 15, 2015, the contents of which are incorporated herein by reference in their entirety.

### BACKGROUND OF THE INVENTION

1. Field of the Invention

The present disclosure relates to display devices, display systems, and storage media.

2. Description of the Related Art

A display device such as a projector which receives images from multiple terminal devices, and displays the received images on divided display regions is known in the art. For example, such a display device divides a display region into the first display region and the second display region, and then displays the first image, which is received from the first terminal device, on the first display region, and displays the second image, which is received from the second terminal device, on the second display region. Regarding such a displaying method, it is suggested that a terminal device enlarges a predetermined part of an image and sends the enlarged image, so that a display device displays the enlarged image (for example, see Japanese Unexamined Paten Application Publication No. 2004-54134).

### SUMMARY OF THE INVENTION

One aspect of the present invention provides a display device, in which a display region is divided into a plurality of divided display regions so as to display a plurality of images received from a plurality of terminal devices, and the plurality of divided display regions are assigned to the plurality of terminal devices, respectively, the display device including a receiver configured to receive the plurality of images from the plurality of terminal devices, respectively, a determiner configured to determine to crop at least one of the plurality of images, upon detecting that some or all of the plurality of images including the at least one of the plurality of images have more than a predetermined number of parts in common, a cropper configured to crop one of the plurality of images and configured to generate a new image based on a cropped part of the one of the plurality of images, in response to a determination of the determiner to crop the one of the plurality of images, and a display controller configured to adjust the size of the new image in accordance with a size of one of the plurality of divided display regions assigned to one of the plurality of terminal devices from which the one of the plurality of images is received and configured to display the new image having the adjusted size on the one of the plurality of divided display regions.

### BRIEF DESCRIPTION OF THE DRAWINGS

FIG. 1 is a drawing illustrating an example of a display system according to a first embodiment;

FIGS. 2A through 2C are drawings illustrating examples of a display region of a display device according to the first embodiment;

FIG. 3 is a drawing illustrating an example of a hardware configuration of the display device according to the first embodiment;

FIG. 4 is a drawing illustrating an example of functional configurations of the display system according to the first embodiment;

FIGS. 5A and 5B are drawings illustrating a first example of a cropping region designated by a cropping region designator according to the first embodiment;

FIG. 6 is a drawing illustrating a second example of a cropping region according to the first embodiment;

FIGS. 7A through 7C are drawings illustrating examples of a layout of a display region according to the first embodiment;

FIG. 8 is a drawing illustrating an example of a switching motion between a full-screen display and a divided-screen display according to the first embodiment;

FIG. 9 is a drawing illustrating an example of an adjustment motion according to the first embodiment;

FIG. 10 is a drawing illustrating an example of information stored in storage according to the first embodiment;

FIG. 11 is a drawing illustrating an operation sequence according to the first embodiment;

FIGS. 12A through 12C are drawings illustrating examples of divided display regions according to the first embodiment;

FIG. 13 is a first example of a flowchart according to the first embodiment;

FIG. 14 is a second example of a flowchart according to the first embodiment;

FIG. 15 is a drawing illustrating an example of functional configurations according to a second embodiment; and

FIG. 16 is a drawing illustrating an operation sequence according to the second embodiment.

### DESCRIPTION OF THE EMBODIMENTS

In the traditional displaying method, a terminal device generates an enlarged image, and therefore it is difficult for a display device to change the size of the enlarged part of the image in accordance with the conditions of the display region.

In view of such a background, the object of the present invention is that the size of a predetermined part of a displayed image becomes adjustable in accordance with conditions of the display region.

### First Embodiment

### System Configuration

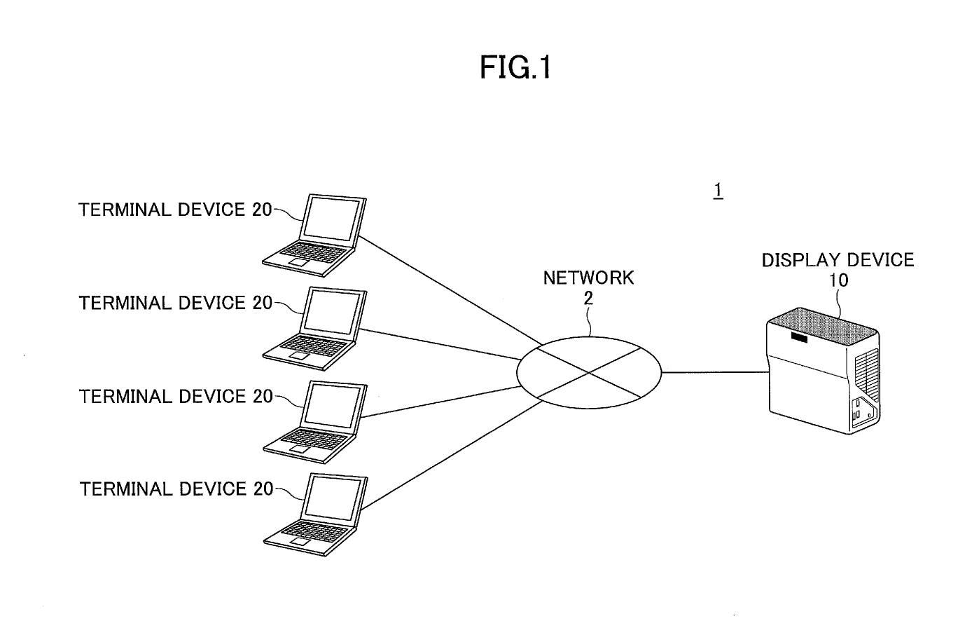

FIG. 1 is a drawing illustrating an example of a display system 1 according to the first embodiment. The display system 1 includes a display device 10 and terminal devices 20. The display device 10 and the terminal devices 20 are connected through a network 2. The network 2 may be wired or wireless. Here, in the description below, an unspecified terminal device is referred to as a terminal device 20, whereas specified terminal devices are referred to as the terminal devices 20A through 20D.

The display device 10, such as a projector and a display, has functions for receiving and displaying an image. Here, the image may be a still image or moving image.

The terminal device 20 may be, for example, a personal computer (PC), a smartphone, and a tablet.

The display device 10 and the terminal devices 20 transmit and receive signals through the network 2. The terminal devices 20 transmit images to the display device 10. The display device 10 displays received images. The display device 10 receives images from each of the terminal devices 20, and displays the received images.

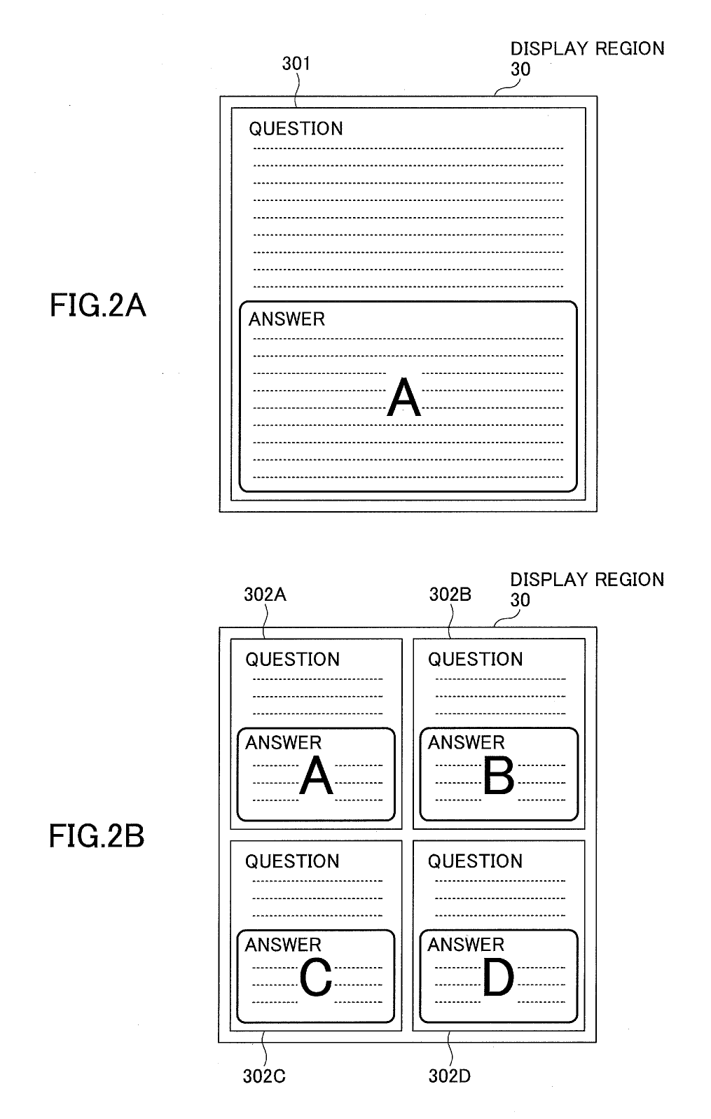

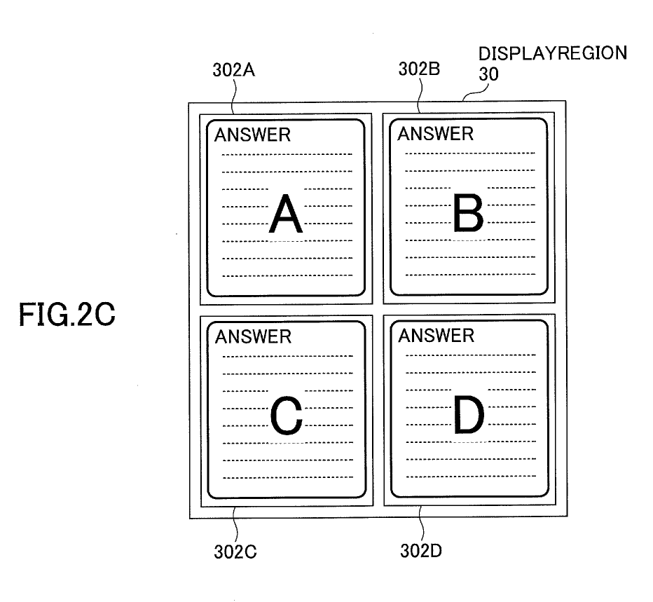

FIGS. 2A through 2C are drawings illustrating examples of a display region 30 of the display device 10 according to the first embodiment. The display device 10 displays the images received from the terminal devices 20A through 20D on the display region 30.

In FIG. 2A, the display device 10 receives an image from the terminal device 20A, and displays the received image on the whole display region 301 of the display region 30. In a case of receiving an image from a single terminal device 20, the display device 10 displays the image on the whole display region 301 of the display region 30.

In FIG. 2B, the display device 10 receives images from the terminal devices 20A through 20D, and displays the images on the display region 30.

The display device 10 divides the display region 30, so as to display the images received from each of the terminal devices 20A through 20D. In a case of receiving images from multiple terminal devices 20, the display device 10 divides the display region 30 to form divided display regions 302, so as to display each of the received images. In FIG. 2B, the image received from the terminal device 20A is displayed on the divided display region 302A, the image received from the terminal device 20B is displayed on the divided display region 302B, the image received from the terminal device 20C is displayed on the divided display region 302C, the image received from the terminal device 20D is displayed on the divided display region 302D. Here, in the description below, an unspecified divided display region is referred to as a divided display region 302, whereas specified divided display regions are referred to as the divided display regions 302A through 302D.

When displaying images in such a way as illustrated in FIG. 2B, it may be difficult to recognize the images because the display size of each of the images is too small. Furthermore, it may be difficult to compare specific parts of each of the images because the display size of each of the images is too small. Here, the display device 10 may be arranged so as to display parts of the received images on each of the divided display regions 302A through 302D, in a case where some or all of the received images have more than a predetermined number of parts in common. In FIG. 2C, the display device 10 displays parts of the images received from the terminal devices 20A though 20D on the display region 30.

Here, an explanation is provided along with an example of a case of comparing answers of students to a question at school. The display device 10 receives images from each of the terminal devices 20A through 20D used by students. Each of the images includes the question and the answer to the question provided by a student using the respective one of the terminal devices 20A through 20D. The display device 10 determines that some or all of the received images have more than a predetermined number of parts in common. Here, the parts in common are regions where the question is displayed.

The display device 10 displays parts of the received images on the divided display regions 302A through 302D. Here, when displaying the parts of the received images, the display device 10 adjusts the sizes of the parts of the received images to fit the divided display regions 302A through 302D which are respectively assigned to the images. In the example of FIG. 2C, the regions for displaying the answers, that is to say, the regions uncommon to all of the images, are enlarged and displayed on the respective divided display regions 302A through 302D. Specifically, the answer of the images received from the terminal device 20A is displayed on the divided display region 302A, the answer of the images received from the terminal device 20B is displayed on the divided display region 302B, the answer of the images received from the terminal device 20C is displayed on the divided display region 302C, the answer of the images received from the terminal device 20D is displayed on the divided display region 302D.

Here, the display device 10 may be arranged so as not to enlarge parts of the images regarding some images received from the terminal devices 20. For example, the display device 10 may be arranged to display the image received from the terminal device 20A in such a way as to include both the question and answer, whereas the images received from the other devices may be displayed in such a way as to only include the answers, which are parts of the images.

The display device 10 may be arranged so as to receive a password from the terminal device 20, and to receive and display images in a case where the password matches a password stored in the display device 10.

<Hardware Configuration>

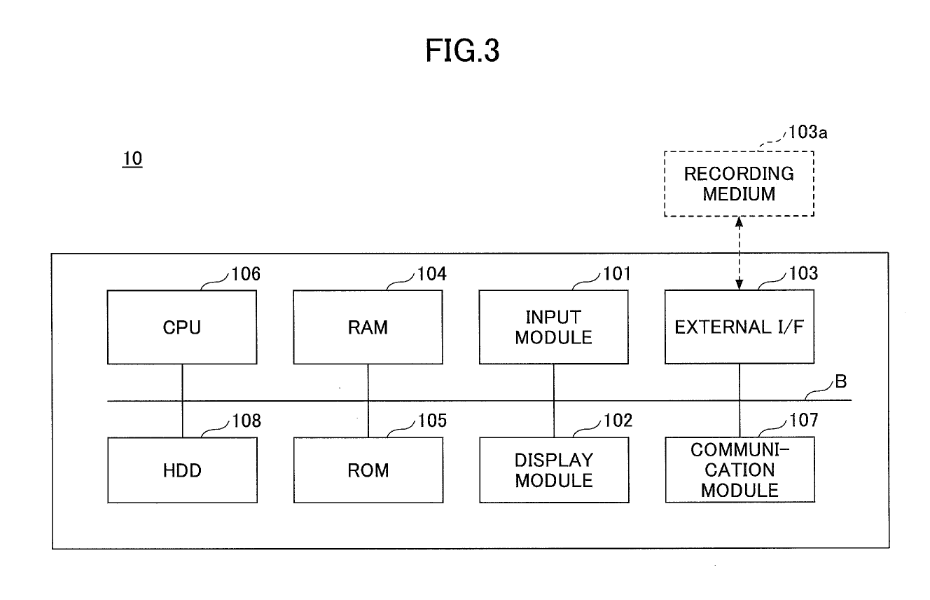

FIG. 3 is a drawing illustrating an example of a hardware configuration of the display device 10 according to the first embodiment.

The display device 10 includes an input module 101, a display module 102, an external interface (I/F) 103, a random access memory (RAM) 104, a read-only memory (ROM) 105, a central processing unit (CPU) 106, a communication module 107, and a hard disk drive (HDD) 108, which are mutually connected through a bus B.

The input module 101, such as a keyboard, a mouse, and a touch panel, is for a user to input operating signals.

The display module 102 is provided with a light source such as an electric light, so as to project images received from the terminal device 20. The display module 102 displays images processed by the CPU 106, etc.

The communication module 107 connects the display device 10 to the network 2. The display device 10 and the terminal device 20 transmit and receive data with each other through the communication module 107. Furthermore, the display device 10 receives images from the terminal device 20.

The HDD 108 is a non-volatile memory device storing programs and data. The stored programs and data are, for example, an operating system (OS), which is a basic software program for entirely controlling the display device 10, and application software programs, which are operated on the OS for providing a variety of functions, etc.

The HDD 108 manages the stored programs and data in a predetermined file system and/or database (DB).

The external I/F 103 is an interface to external devices, such as a recording medium 103a. The display device 10 performs read and/or write processing on the recording medium 103a through the external I/F 103.

The recording medium 103a is, for example, a flexible disk, a compact disk (CD), a digital versatile disk (DVD), a secure digital (SD) memory card, a universal serial bus (USB), etc.

The ROM 105 is a non-volatile semiconductor memory (memory device) which is capable of storing programs and data even when the power is off. The ROM 105 stores programs and data such as a basic input/output system (BIOS) which is executed upon booting the display device 10, OS settings, and network settings.

The RAM 104 is a volatile semiconductor memory (memory device) for temporarily storing programs and data.

The CPU 106 is an arithmetic device which reads out the programs and data from the memory devices such as the ROM 105 and the HDD 108 and performs processing so as to actualize the entire control and functions of the display device 10.

The CPU 106 executes programs stored in the CPU 106 and the ROM 105, so that the display device 10 actualizes a variety of functions as described hereinafter. The terminal device 20 and the display device 10 have the same hardware configurations except that the display module 102 of the terminal device 20 is a regular display.

<Functional Configuration>

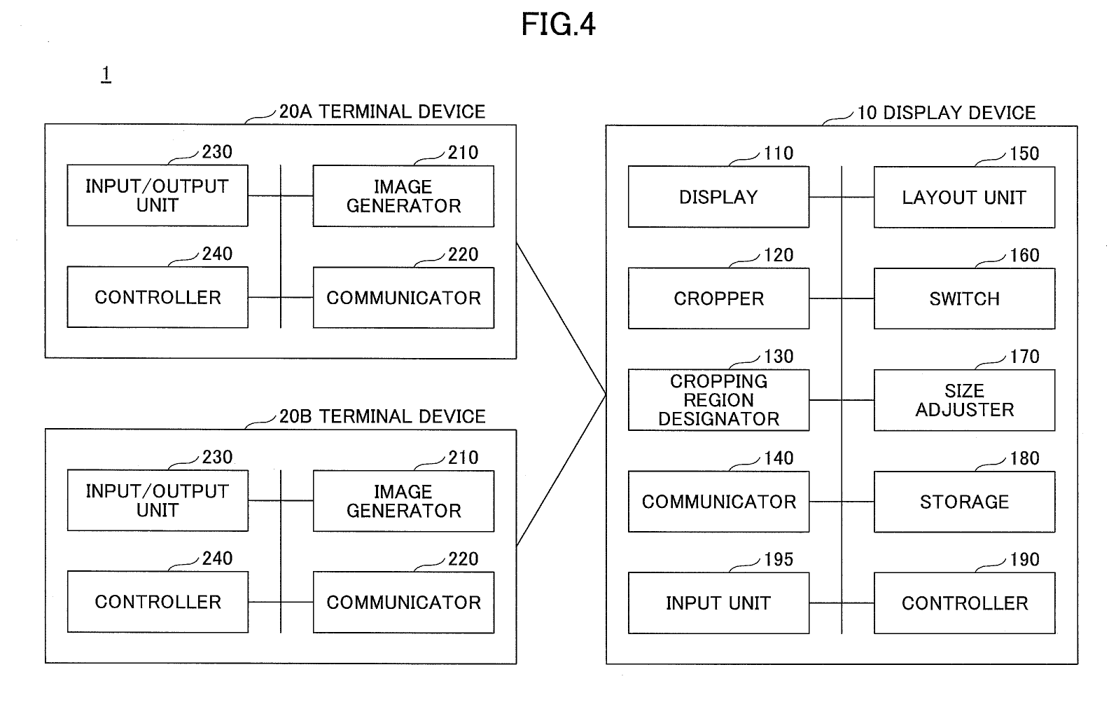

FIG. 4 is a drawing illustrating an example of functional configurations of the display system 1 according to the first embodiment. The functional configurations of the display device 10 and the terminal devices 20A and 20B will be explained, with reference to FIG. 4.

(1) Display Device

The display device 10 includes a display 110, a cropper 120, a cropping region designator 130, a communicator 140, a layout unit 150, a switch 160, a size adjuster 170, storage 180, a controller 190, and an input unit 195.

The cooperation of each part of the display device 10 is as follows. The display device 10 assigns divided display regions 302 respectively to the terminal devices 20, so as to display images received from the terminal devices 20 on the divided display regions 302 formed in the display region 30. In the display device 10, the communicator 140 receives images from each of the terminal devices 20. Then, in a case where some or all of the received images have more than a predetermined number of parts in common, the cropper 120 determines to crop a part of at least one of the received images. Then, in a case where the cropper 120 determines to crop an image, the cropping region designator 130 crops the image determined to be cropped, and generates a new image. Then, the layout unit 150 controls the displaying of the generated new image, so that the new image fits the divided display region 302 assigned to the terminal device 20 which transmits the image.

The cooperation of each part of the display device 10 may be as follows. The communicator 140 receives the first image from the terminal device 20A and receives the second image from the terminal device 20B. The switch 160 divides the display region 30 into multiple regions including the divided display regions 302A and 302B. Then, the display 110 displays the third image, which is the first image itself or a part of the first image, on the divided display region 302A, and displays the fourth image, which is the second image itself or a part of the second image, on the divided display region 302B.

In a case where the first image and the second image have more than a predetermined number of parts in common, the display 110 displays at least one of the third image and the fourth image on the corresponding divided display region 302A and/or the corresponding divided display region 302B. When displaying the third image and/or the fourth image, the display 110 adjusts the size of the images so that the images fit the divided display regions 302A and 302B.

Specifically, each part has such a function as described below.

When displaying images, the display 110 adjusts the sizes of images received from each of the terminal devices 20 based on instructions from the layout unit 150, etc., so that the images fit the divided display regions 302.

The cropper 120 determines the need for cropping each of the images received from the terminal devices 20. In a case of receiving the first image from the terminal device 20A and receiving the second image from the terminal device 20B, the cropper 120 determines the need for cropping the first image and generating the third image, which is a part of the first image. The cropper 120 may determine the need for cropping images only in a case of receiving images from multiple terminal devices 20.

In a case where the first image and the second image have more than a predetermined number of parts in common, the cropper 120 crops the first image and generates the third image, which is a part of the first image. The cropper 120 may crop some of the images received from the multiple terminal devices 20 or may crop all of the images received from the multiple terminal devices 20. Specifically, the cropper 120 compares the received images with each other, so as to determine whether some or all of the images have more than a predetermined number of parts in common.

Here, the cropper 120 may determine that the first image and the second image have parts in common, not only in a case where certain regions of the first image and the second image are identical, but also in a case where certain regions of the first image and the second image match over a predetermined ratio. For example, the cropper 120 may determine that the first image and the second image have parts in common, in a case where pixel values of the first image and the second match over 80 percent in certain regions. Alternatively, the cropper 120 may determine that the first image and the second image have parts in common, in a case where the first image and the second image have the same tag information, etc., in certain regions.

The cropper 120 may generate the third image in a case where the divided display region 302 is smaller than a predetermined size, because, in a case of displaying an image on the divided display region 302 without cropping when the divided display region 302 is smaller than the predetermined size, the displayed image may be visually unperceivable.

The cropping region designator 130 designates cropping regions of each of images which the cropper 120 determines to have the need for cropping.

When cropping the first image, the cropping region designator 130 designates a cropping region based on information indicating the common parts of multiple images which are detected by the cropper 120. The cropping region designator 130 may crop parts uncommon to the first image and the second image, and generates the third image. The cropping region designator 130 crops images received from the terminal devices 20, and generates new images.

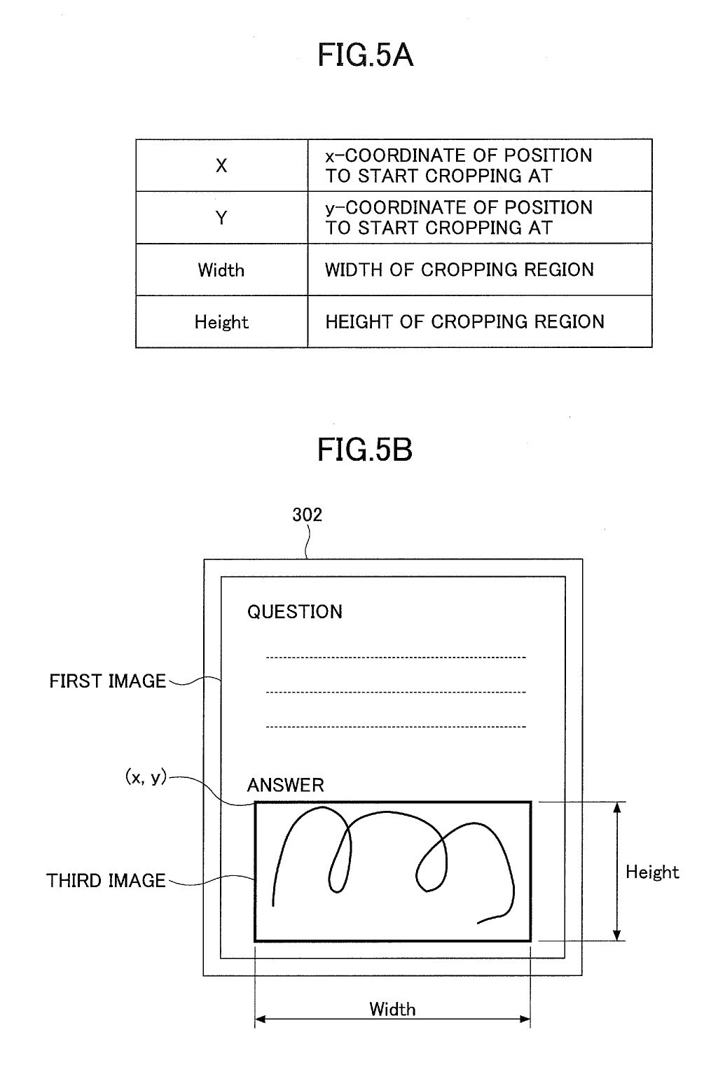

FIGS. 5A and 5B are drawings illustrating the first example of a cropping region designated by the cropping region designator 130 according to the first embodiment.

The cropping region designator 130 may designate a region of the first image and generate the third image, based on coordinate values (x, y) to start cropping the first image at, a width and a height of the cropping region.

The cropping region designator 130 may designate a cropping region based on the property of a received image, such as tag information indicating regions, information for specifying regions for displaying applications, and information for specifying certain regions of documents, which are included in the received image. Furthermore, the cropping region designator 130 may designate a region of the received image based on html tag information, xml tag information, etc.

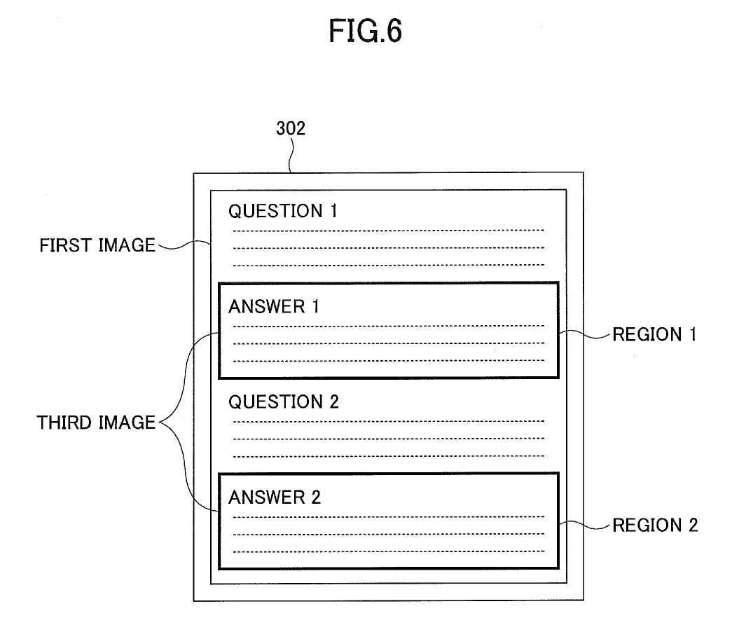

FIG. 6 is a drawing illustrating the second example of a cropping region according to the first embodiment.

The cropping region designator 130 may designate multiple regions of the first image as cropping regions. As illustrated in FIG. 6, the cropping region designator 130 may designate regions 1 and 2 of the first image, and generate the third image.

The communicator 140 and the terminal device 20 transmit and receive data with each other. Furthermore, the communicator 140 receives an image from the terminal device 20, and then transmits the received image to relevant parts of the display device 10 based on instructions from the controller 190.

The layout unit 150 determines an arrangement of the divided display regions 302 which are formed by dividing the display region 30, and determines an image to be displayed on each of the divided display regions 302 among the images received from the terminal devices 20.

The layout unit 150 determines the arrangement of the divided display regions 302 and an image to be displayed on each of the divided display regions 302 in a case where the switch 160 determines to display the images on the display region 30 with multiple screens. The layout unit 150 notifies the display 110 of the determination of the layout unit 150, and instructs the display 110 to adjust the sizes of the images so as to display the images on the respective divided display regions 302. The display 110 displays the images in accordance with the determination.

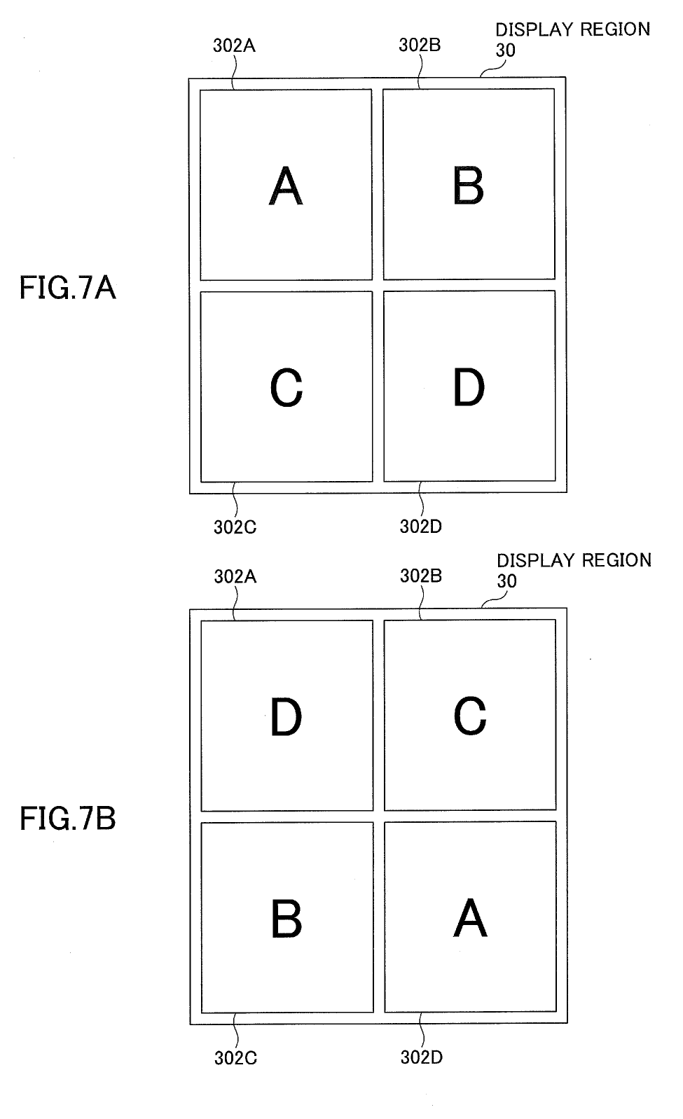

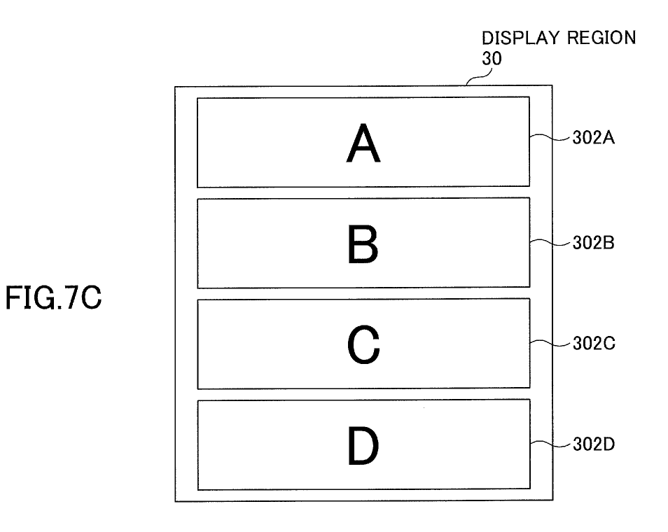

FIGS. 7A through 7C are drawings illustrating examples of a layout of the display region 30. In FIGS. 7A through 7C, the layout unit 150 determines that the image received from the terminal device 20A is displayed on the divided display region 302A, that the image received from the terminal device 20B is displayed on the divided display region 302B, that the image received from the terminal device 20C is displayed on the divided display region 302C, and that the image received from the terminal device 20D is displayed on the divided display region 302D, and then instructs the display 110 to display the images in accordance with the determination. As illustrated in FIGS. 7A and 7B, the layout unit 150 may change the divided display regions 302A through 302D for respectively displaying the images received from the terminal devices 20A through 20D. The layout unit 150 may determine an image to be displayed on each of the divided display regions 302A through 302D based on a user operation received by the input unit 195 or based on an instruction received from the terminal devices 20A through 20D.

In a case where the cropping region designator 130 crops an image received from the terminal device 20 and generates a new image, the layout unit 150 assigns the new image to a divided display region 302. The layout unit 150 instructs the display 110 to display the new image on the assigned divided display region 302.

The layout unit 150 may determine the layouts and the sizes of the divided display regions 302A through 302D based on the aspect ratio of the new image. For example, as illustrated in FIG. 7C, the layout unit 150 may form the divided display regions 302A through 302D in a landscape-oriented rectangular shape.

The switch 160 switches between a full-screen display, on which an image is displayed on the whole display region 301 of the display region 30, and a divided-screen display, on which images are displayed on the divided display regions 302. The switching motion may be performed in response to a user operation received by the input unit 195 or based on an instruction received from the terminal device 20.

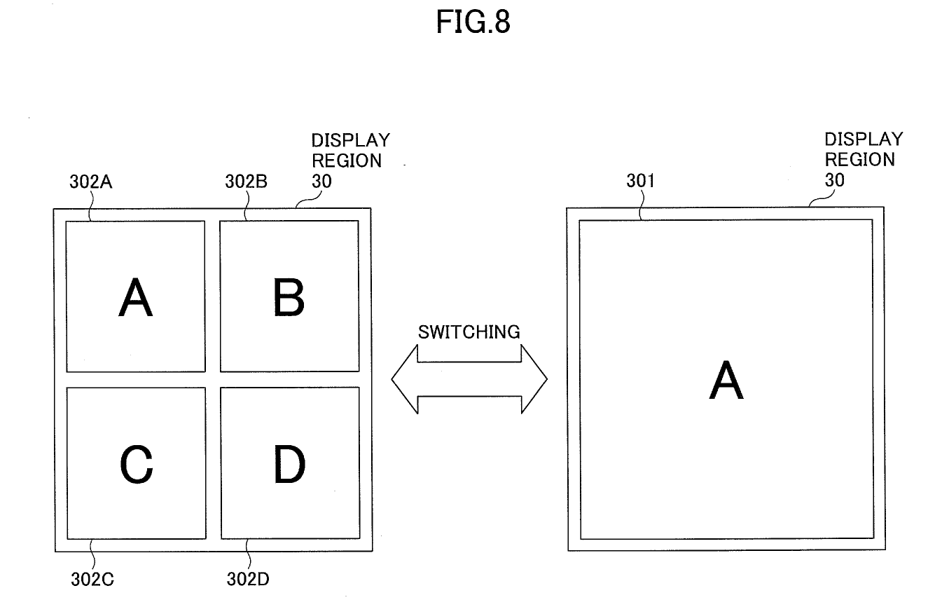

FIG. 8 is a drawing illustrating an example of the switching motion between the full-screen display and the divided-screen display according to the first embodiment.

The switch 160 determines an image to be displayed on the whole region 301 of the display region 30 among the images assigned to each of the divided display regions 302A through 302D. When switching from the divided-screen display to the full-screen display, the switch 160 may display an uncropped image on the whole region 301 of the display region 30.

The size adjuster 170 cooperates with the layout unit 150, so as to adjust the sizes of the divided display regions 302A through 302D.

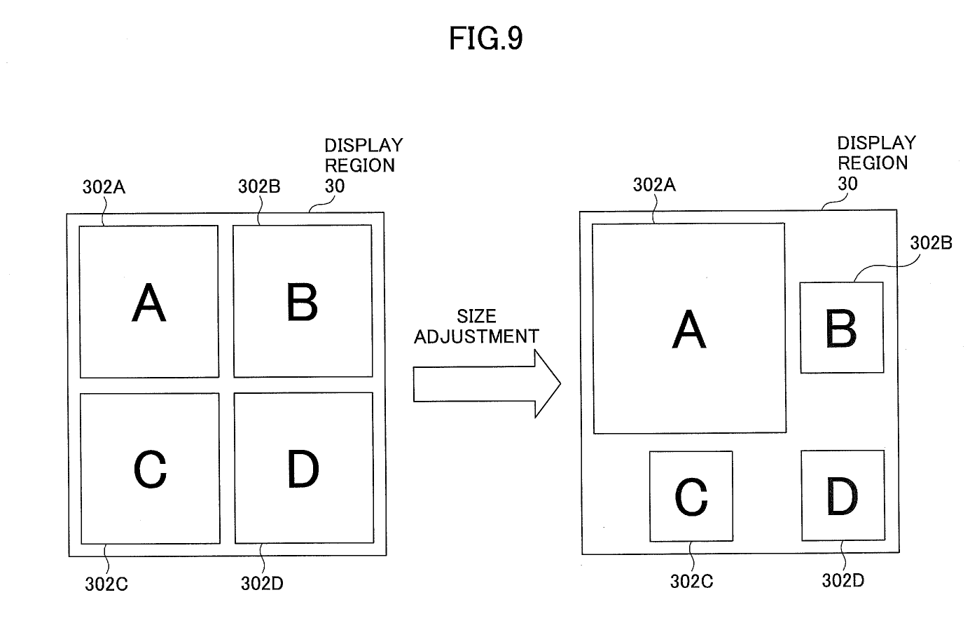

FIG. 9 is a drawing illustrating an example of an adjustment motion according to the first embodiment. The size adjuster 170 performs scaling of the divided display regions 302A through 302D based on a user operation received by the input unit 195 or an instruction received from the terminal devices 20. In the example of FIG. 9, the size adjuster 170 enlarges the size of the divided display region 302A and reduces the sizes of the other divided display regions 302B through 302D. After the size adjuster 170 cooperates with the layout unit 150 to perform size adjustments, the layout unit 150 instructs the display 110 to display the images in accordance with the adjustment result.

The storage 180 stores the images received from the terminal devices 20, the divided display regions 302 assigned to each of the images received from the terminal devices 20, and the cropped regions of the images received from the terminal devices 20 in a corresponding manner.

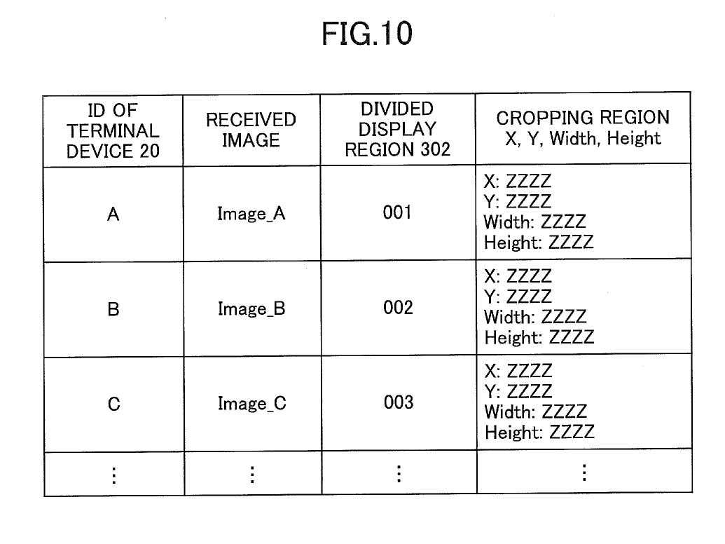

FIG. 10 is a drawing illustrating an example of information stored in the storage 180 according to the first embodiment. In the section of “ID OF TERMINAL DEVICE 20”, identifiers of the terminal devices 20 which images are received from are stored. The format of the identifiers is not limited as long as the identifiers identify all of the terminal devices 20. For example, a media access control (MAC) address may be used as identifiers of the terminal devices 20. In the section of “RECEIVED IMAGE”, information of the images received by the communicator 140 from the terminal devices 20 is stored. In the section of “DIVIDED DISPLAY REGION 302”, information for specifying a divided display region 302 assigned to each of the terminal devices 20 by the layout unit 150 is stored. In the section of “CROPPING REGION”, cropping regions designated by the cropping region designator 130 are stored. Tag information of cropped images may be stored in the section of “CROPPING REGION”. New images generated by specifying cropping regions may be stored in the storage 180.

In a case of receiving an instruction from the layout unit 150 regarding the displaying on the display region 30, the display 110 may determine objects to be displayed based on the information stored in the storage 180.

The controller 190 coordinates processes of each part, and provides instruction to each part. The input unit 195 receives instructions from users of the display device 10 regarding the displaying, etc., and then transmits the received instructions to relevant parts such as the controller 190.

(2) Terminal Device

The terminal device 20 includes an image generator 210, a communicator 220, an input/output unit 230, and a controller 240 (see FIG. 4).

The image generator 210 generates images to be displayed by the display device 10. The communicator 220 transmits the generated images to the display device 10. Furthermore, the communicator 220 receives signals from the display device 10, and then transmits the received signals to the controller 240. The controller 240 coordinates processes of each part, and provides instruction to each part.

<Operation Sequence>

(1) Operation Sequence

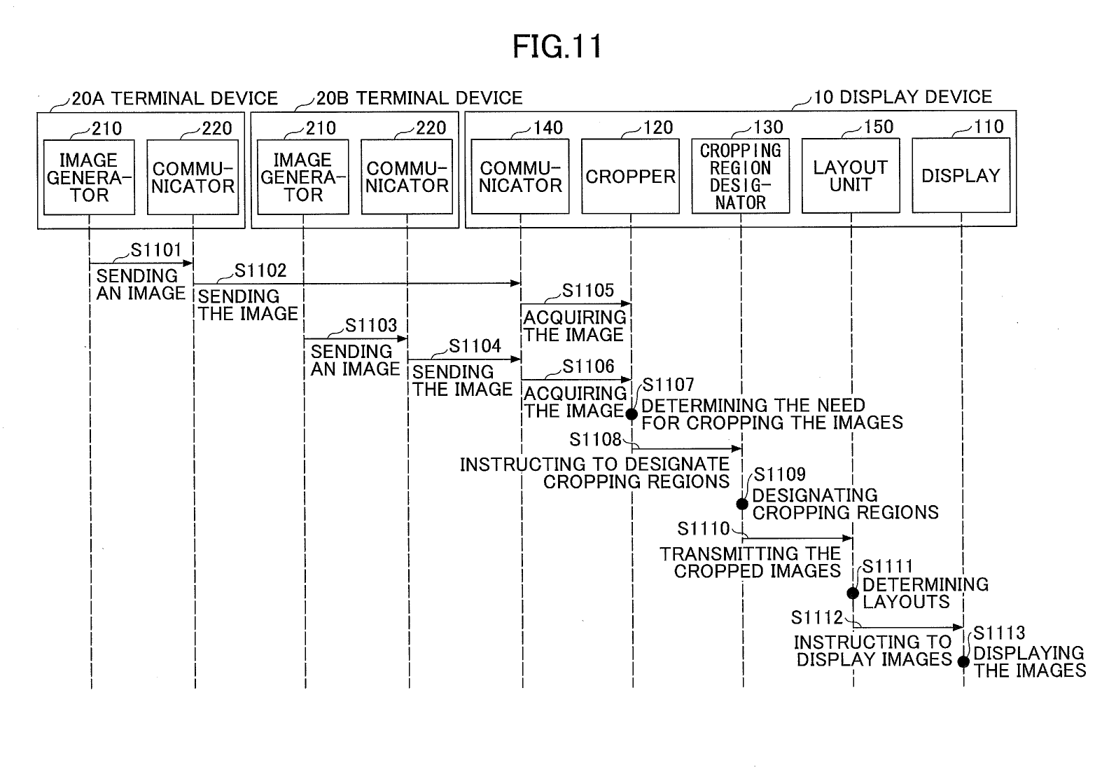

FIG. 11 is a drawing illustrating an operation sequence according to the first embodiment.

In step S1101, the image generator 210 of the terminal device 20A sends a generated image to the communicator 220.

In step S1102, the communicator 220 of the terminal device 20A sends the image to the display device 10.

Steps S1103 and S1104 are the same as steps S1101 and S1102. The terminal device 20B sends an image to the display device 10.

In step S1105, the cropper 120 of the display device 10 acquires the image sent from the terminal device 20A to the communicator 140.

In step S1106, the cropper 120 of the display device 10 acquires the image sent from the terminal device 20B to the communicator 140.

The cropper 120 acquires all of the images sent from the terminal devices 20, and then determines the need for cropping the images. The determination of the cropper 120 may be based on information of the display region 30 and the divided display regions 302 acquired from the layout unit 150.

In step S1107, the cropper 120 determines the need for cropping each of the received images. For example, the cropper 120 may determine that the images need to be cropped in a case where the sizes of the divided display regions 302 are smaller than a predetermined size. Furthermore, the cropper 120 may determine that the images need to be cropped in a case where the received images have more than a predetermined number of parts in common.

In step S1108, the cropper 120 instructs the cropping region designator 130 to designate cropping regions of an image which is determined to have the need for cropping.

In step S1109, the cropping region designator 130 designates the cropping regions of the images.

For example, the cropping region designator 130 may crop regions uncommon to each of the received images. Alternatively, the cropping region designator 130 may designate cropping regions based on tag information indicating regions which are included in the received images. The cropping region designator 130 designates cropping regions, and generates new images.

In step S1111, the layout unit 150 determines the layouts of the new images. Specifically, the layout unit 150 determines the positions and the sizes of the divided display regions 302 in the display region 30, and then determines an image to be displayed on each of the divided display regions 302 among the received images.

In step S1112, the display 110 receives an instruction regarding layouts from the layout unit 150. The display 110 may receive the new images, together with the instruction regarding layouts.

In step S1113, the display 110 displays images. Here, the display 110 may acquire the new images from the storage 180.

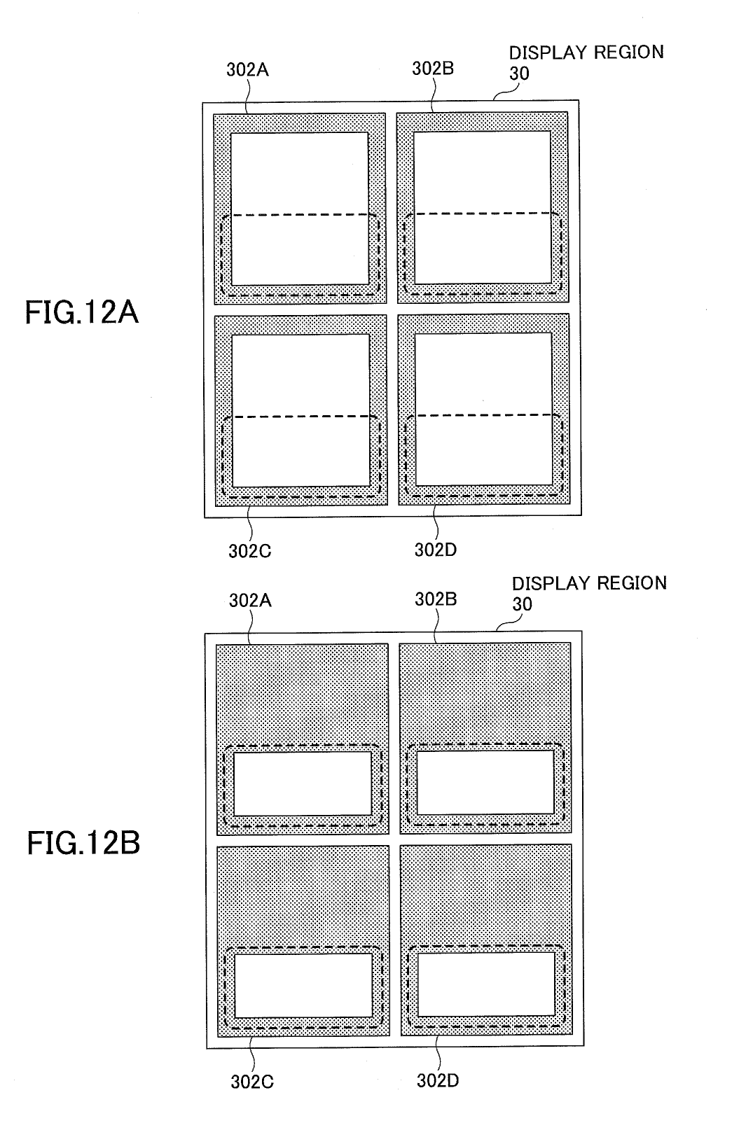

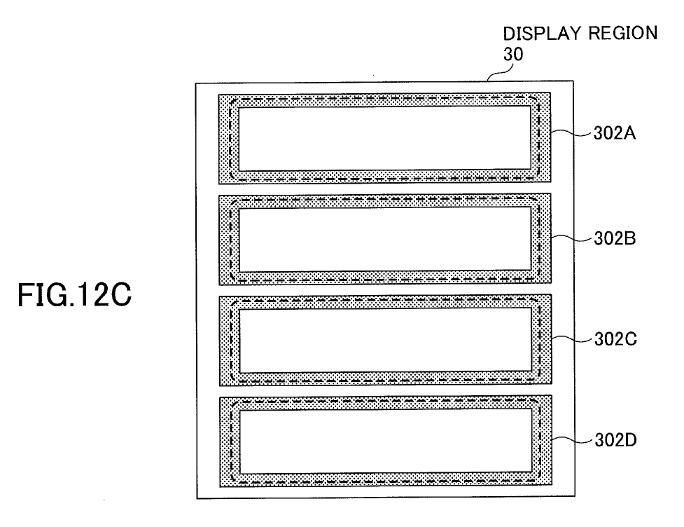

Here, the layout unit 150 determines the layouts of the divided display regions 302 based on the aspect ratios of the new images. FIGS. 12A through 12C are drawings illustrating examples of the divided display regions 302 according to the first embodiment.

For example, when the cropping region designator 130 crops the regions marked with the dashed lines as illustrated in FIG. 12A and generates new images, in a case of dividing the display region 30 into a 2 by 2 matrix as illustrated in FIG. 12B, the new images cannot be enlarged because of the aspect ratios of the new images. Here, the layout unit 150 may determine the layouts of the divided display regions as illustrated in FIG. 7C based on the aspect ratios of the new images, so as to instruct the display 110 to display the new images which are enlarged to the sizes that fit the divided display regions 302A through 302D.

(2) Flowchart 1

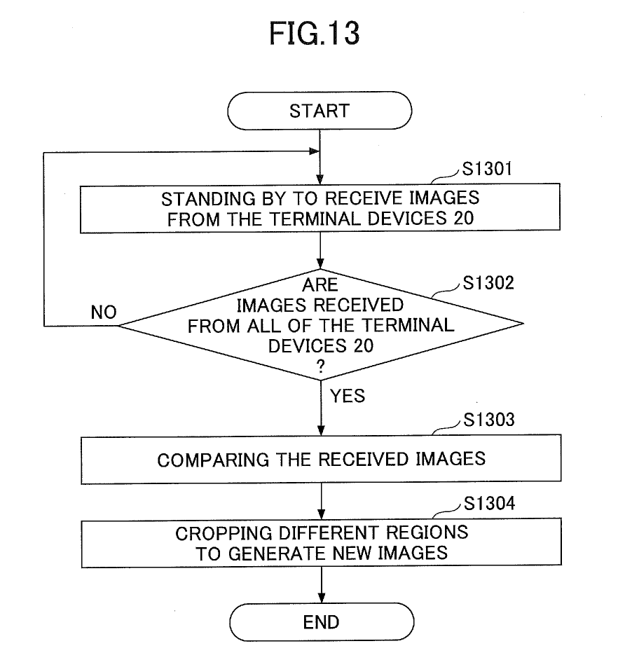

FIG. 13 is the first example of a flowchart according to the first embodiment.

In step S1301, the display device 10 stands by to receive images from the terminal devices 20.

In step S1302, the communicator 140 determines whether to receive images from all of the terminal devices 20 connecting to the display device 10. In a case of receiving images from all of the terminal devices 20, the processing sequence proceeds to step S1303. On the other hand, in a case of not receiving images from all of the terminal devices 20, the processing sequence returns back to step S1301.

In step S1303, the cropper 120 compares the images received from each of the terminal devices 20, and then determines the need for cropping the images. For example, in a case where the images received from the terminal device 20 have more than a predetermined number of parts in common, the cropper 120 determines that the images need to be cropped.

In step S1304, the cropper 120 instructs the cropping region designator 130 to crop the images, and then the cropping region designator 130 determines cropping regions, and to generate new images. For example, the cropping region designator 130 may crop regions uncommon to each of the received images and generate new images.

(2) Flowchart 2

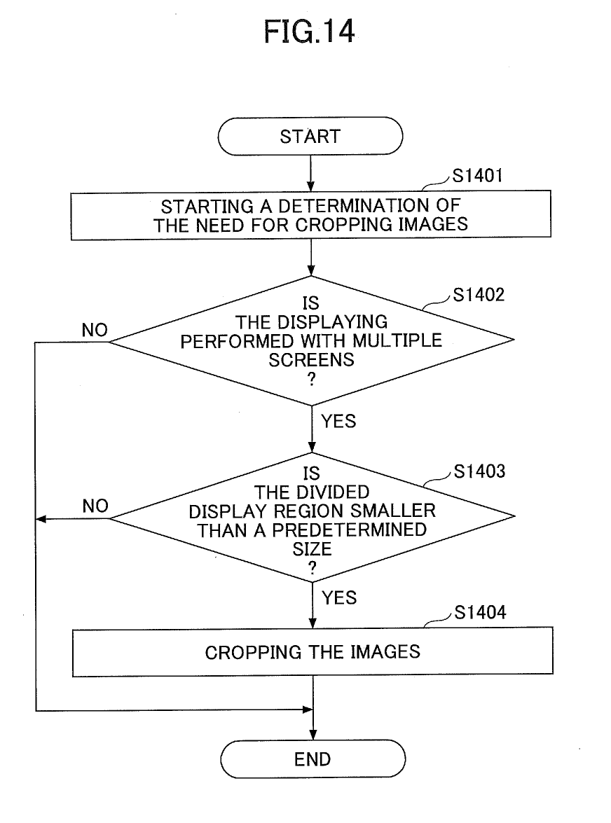

FIG. 14 is the second example of a flowchart according to the first embodiment.

In step S1401, the cropper 120 of the display device 10 starts determining the need for cropping an image.

In step S1402, the cropper 120 determines whether the displaying is performed with multiple screens. In a case where the displaying is performed with multiple screens, the processing sequence proceeds to step S1403. On the other hand, in case of the displaying is performed on the full screen, the processing is terminated.

In step S1403, the divided display region 302 assigned to display the image is determined whether to be larger than a predetermined size. In a case of being larger than the predetermined size, the processing sequence proceeds to step S1404. On the other hand, in a case of being smaller than the predetermined size, the processing is terminated.

In step S1404, the cropper 120 instructs the cropping region designator 130 to designate a cropping region. The cropping region designator 130 designates a cropping region, and then crops the image and generates a new image.

### Second Embodiment

The second embodiment will be explained in the following. Here, the explanations of parts in common with the first embodiment will be omitted, and only parts that differ from the first embodiment will be explained.

<Functional Configuration>

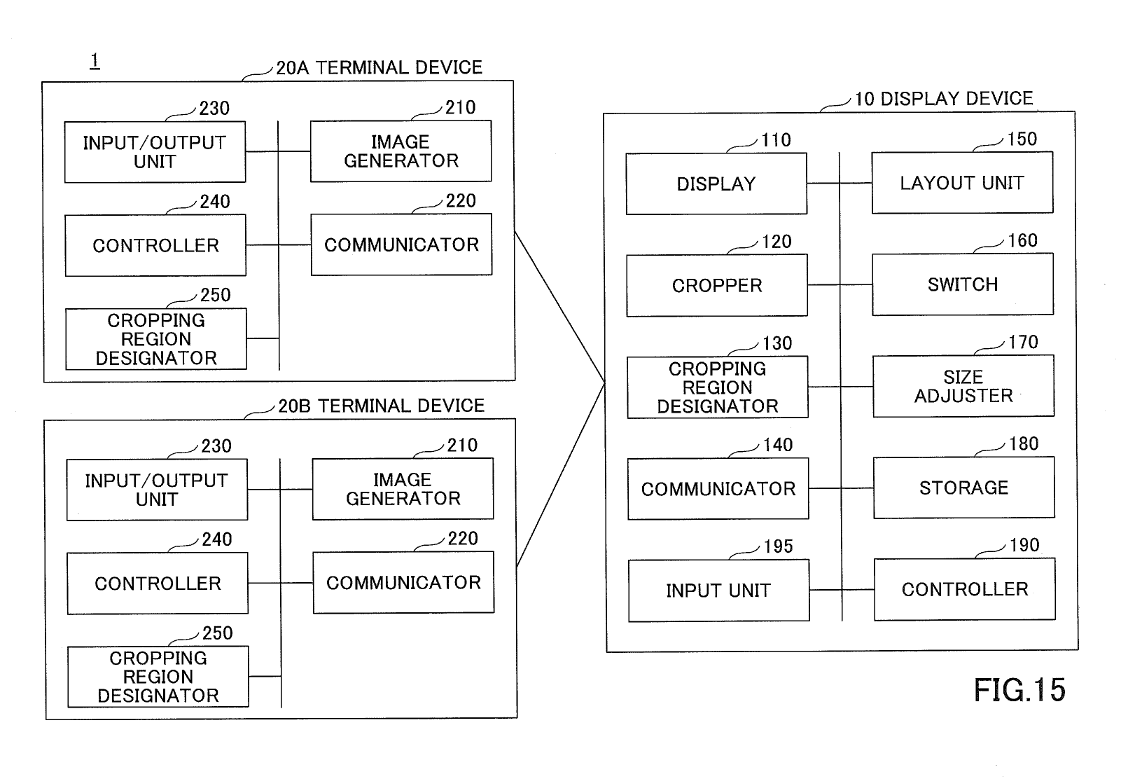

FIG. 15 is a drawing illustrating an example of functional configurations according to the second embodiment. The functional configurations of the display device 10 and the terminal devices 20 according to the second embodiment will be explained with reference to FIG. 15.

(1) Display Device

In the second embodiment, the cropping region designator 130 of the display device 10 may designate cropping regions. Alternatively, the cropping regions may be designated by the terminal devices 20 and then sent to the display device 10.

In a case of determining the need for cropping an image received from the terminal device 20, the cropper 120 instructs the terminal device 20 which sent the image to designate a cropping region.

The cropper 120 receives from the terminal device 20 a response to the instruction through the communicator 140. The response may include information indicating the cropping region of the image and/or a new image generated by cropping.

Upon receiving the response from the terminal device 20, the cropper 120 instructs the layout unit 150 to display the designated image on the divided display region 302.

Here, in a case of receiving only the information indicating the cropping region of the image, the cropper 120 may generate a new image based on the information, referring to the storage 180.

(3) Terminal Device

The terminal device 20 according to the second embodiment includes a cropping region designator 250. The cropping region designator 250 receives the instruction for designating a cropping region from the display device 10 through the communicator 220. In response to the instruction, the cropping region designator 250 designates a cropping region. For example, the terminal device 20 designates a cropping region based on tag information indicating regions which is included in an image.

The cropping region designator 250 sends information indicating a cropping region and/or a new image generated by cropping to the display device 10 through the communicator 220.

<Operation Sequence>

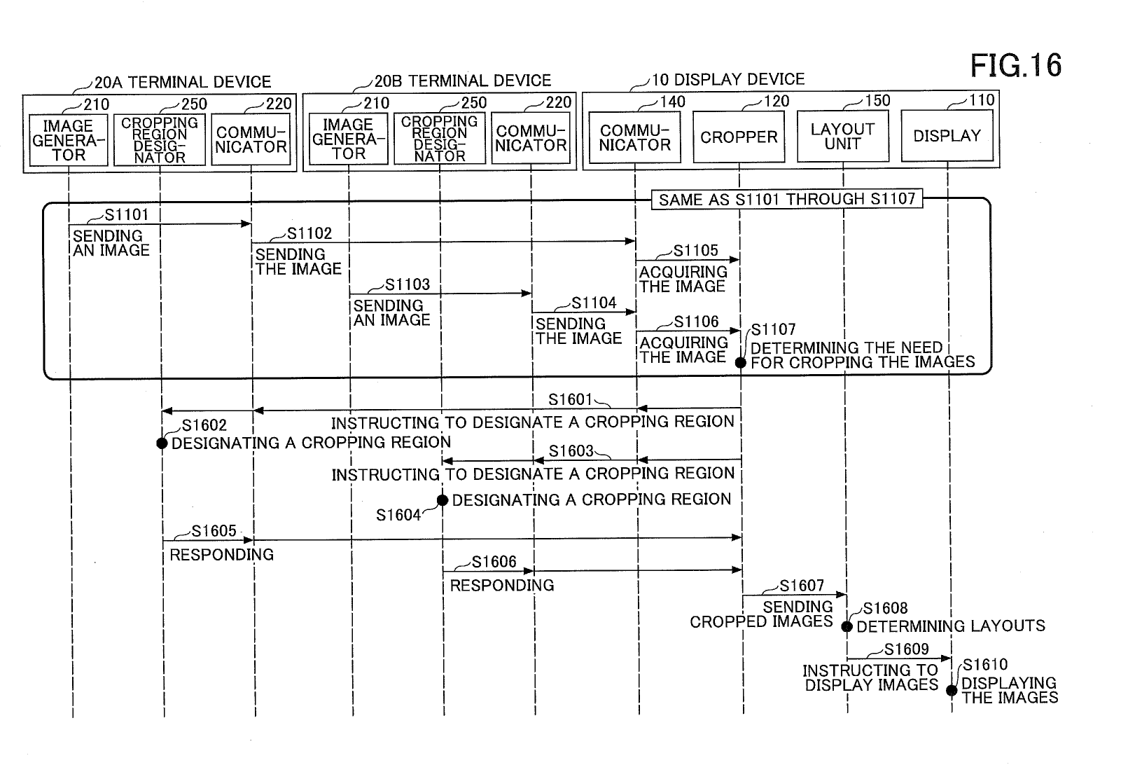

FIG. 16 is a drawing illustrating an operation sequence according to the second embodiment.

Prior to step S1601, the same processing as steps S1101 through S1107 is performed.

In step S1601, the cropper 120 of the display device 10 sends an instruction for designating a cropping region of an image to the terminal device 20A through the communicator 140.

In step S1602, responding to the instruction, the cropping region designator 250 of the terminal device 20A designates a cropping region of the image. The cropping region may be designated based on tag information indicating regions which is included in the image, etc.

Steps S1603 and S1604 are the same as steps S1601 and S1602. The same operation is preformed between the display device 10 and the terminal device 20B.

In step S1605, the cropping region designator 250 of the terminal device 20A sends a response through the communicator 220. The response may include information indicating a cropping region and/or a new image generated by cropping.

Step S1606 is the same as step S1605. The same operation is preformed between the display device 10 and the terminal device 20B.

In step S1607, upon receiving the response from the terminal devices 20A and 20B, the cropper 120 of the display device 10 sends the new images generated by cropping to the layout unit 150.

Here, in a case where new images generated by cropping are not included in the responses from the terminal devices 20A and 20B, the cropper 120 generates new images based on images stored in the storage 180 and the information indicating cropping regions which are included in the responses.

Steps S1608 through S1610 are the same as steps S1111 through S1113, and therefore explanations are omitted.

<Others>

The storage 180 may be provided on a device disposed on the network 2. In such a case, the display device 10 acquires relevant information from the storage 180.

The communicator 140 is an example of a receiver. The communicator 220 is an example of a sender. The cropper 120 is an example of a determiner. Each of the cropping region designator 130 and the image generator 210 is an example of a cropper. The layout unit 150 is an example of a display controller. The first image is an example of one of the images. The second image is an example of another one of the images. The third image is an example of a new image generated from the one of the images. The fourth image is an example of a new image generated from the other one of the images.

The display device 10 and the terminal device 20 may be provided with a storage medium storing program codes of software for actualizing the embodiments above. Here, the display device 10 and the terminal device 20 read out and execute the program codes stored in the storage medium, so as to actualize the embodiments above. In such a case, the functions according to the embodiments above are actualized by the program codes stored in the storage medium, and the storage medium storing the program codes constitutes the configurations of the embodiments. Here, the storage medium refers to a recording medium or a non-volatile storage medium.

In addition, not only executed by a computer for actualizing the functions according the embodiments above, the program codes may cause an OS operated on the computer to perform a part or all of the actual processing. Here, the functions according to the embodiments above are actualized by the processing.

Further, the present invention is not limited to these embodiments, but various variations and modifications may be made without departing from the scope of the present invention.

As explained in the above description, the size of a predetermined part of a displayed image becomes adjustable in accordance with conditions of the display region.

What is claimed is:

1. A display device, in which a display region is divided into a plurality of divided display regions so as to display a plurality of images received from a plurality of terminal devices, the plurality of divided display regions being assigned to the plurality of terminal devices, respectively, the display device comprising:
a receiver configured to receive the plurality of images from the plurality of terminal devices, respectively;
a determiner configured to determine to crop at least one of the plurality of images, upon detecting that some or all of the plurality of images including the at least one of the plurality of images have more than a predetermined number of parts in common;
a cropper configured to crop one of the plurality of images and configured to generate a new image based on a cropped part of the one of the plurality of images, in response to a determination of the determiner to crop the one of the plurality of images; and
a display controller configured to adjust a size of the new image in accordance with a size of one of the plurality of divided display regions assigned to one of the plurality of terminal devices from which the one of the plurality of images is received and configured to display the new image having an adjusted size on the one of the plurality of divided display regions.

2. The display device according to claim 1, wherein the determiner compares the plurality of images with each other in order to determine whether some or all of the plurality of images have more than a predetermined number of parts in common.

3. The display device according to claim 1, wherein the new image is generated upon detecting that a size of one of the plurality of divided display regions is smaller than a predetermined size.

4. The display device according to claim 1,
wherein the receiver receives the one of the plurality of images from the one of the plurality of terminal devices and receives another one of the plurality of images from another one of the plurality of terminal devices, and
wherein the new image is a part of the one of the plurality of images, the part being not common to the one of the plurality of images and the other one of the plurality of images.

5. The display device according to claim 4, wherein the new image is a part of the one of the plurality of images, the part being specified by use of a predetermined property of each of the plurality of images.

6. The display device according to claim 5, wherein the predetermined property is a tag specifying a part of each of the plurality of images, information for specifying a part for displaying an application in each of the plurality of images, or information for specifying a part of a document included in each of the plurality of images.

7. The display device according to claim 4, wherein the display controller switches the plurality of divided display regions into a single display region in order to display the one of the plurality of images or the other one of the plurality of images.

8. The display device according to claim 4, wherein the new image is generated from a plurality of parts of the one of the plurality of images.

9. The display device according to claim 4,
wherein, in response to a determination of the determiner to crop the other one of the plurality of images, the cropper crops the other one of the plurality of images and generates a new image based on a cropped part of the other one of the plurality of images, and
wherein the display controller adjusts sizes of the plurality of divided display regions, based on an aspect ratio of the new image generated from the one of the plurality of images and an aspect ratio of the new image generated from the other one of the plurality of images.

10. A display system including:
a plurality of terminal devices; and
a display device, in which a display region is divided into a plurality of divided display regions so as to display a plurality of images received from the plurality of terminal devices, the plurality of divided display regions being assigned to the plurality of terminal devices, respectively, the display system comprising:
a receiver configured to receive the plurality of images from the plurality of terminal devices, respectively;
a determiner configured to determine to crop at least one of the plurality of images, upon detecting that some or all of the plurality of images including the at least one of the plurality of images have more than a predetermined number of parts in common;
a cropper configured to crop one of the plurality of images and configured to generate a new image based on a cropped part of the one of the plurality of images, in response to a determination of the determiner to crop the one of the plurality of images; and
a display controller configured to adjust a size of the new image in accordance with a size of one of the plurality of divided display regions assigned to one of the plurality of terminal devices from which the one of the plurality of images is received and configured to display the new image having an adjusted size on the one of the plurality of divided display regions.

11. The display system according to claim 10, wherein the cropper is included in each of the plurality of the terminal devices or in the display device.

12. The display system according to claim 10, wherein the determiner compares the plurality of images with each other in order to determine whether some or all of the plurality of images have more than a predetermined number of parts in common.

13. The display system according to claim 10, wherein the new image is generated upon detecting that a size of one of the plurality of divided display regions is smaller than a predetermined size.

14. The display system according to claim 10,
wherein the receiver receives the one of the plurality of images from the one of the plurality of terminal devices and receives another one of the plurality of images from another one of the plurality of terminal devices, and
wherein the new image is a part of the one of the plurality of images, the part being not common to the one of the plurality of images and the other one of the plurality of images.

15. The display system according to claim 14, wherein the new image is a part of the one of the plurality of images, the part being specified by use of a predetermined property of each of the plurality of images.

16. The display system according to claim 15, wherein the predetermined property is a tag specifying a part of each of the plurality of images, information for specifying a part for displaying an application in each of the plurality of images, or information for specifying a part of a document included in each of the plurality of images.

17. The display system according to claim 14, wherein the display controller switches the plurality of divided display regions into a single display region in order to display the one of the plurality of images or the other one of the plurality of images.

18. The display system according to claim 14, wherein the new image is generated from a plurality of parts of the one of the plurality of images.

19. The display system according to claim 14,
wherein, in response to a determination of the determiner to crop the other one of the plurality of images, the cropper crops the other one of the plurality of images and generates a new image based on a cropped part of the other one of the plurality of images, and
wherein the display controller adjusts sizes of the plurality of divided display regions, based on an aspect ratio of the new image generated from the one of the plurality of images and an aspect ratio of the new image generated from the other one of the plurality of images.

20. A non-transitory recording medium storing a program for causing a display device to execute a process, in which a display region is divided into a plurality of divided display regions so as to display a plurality of images received from a plurality of terminal devices, the plurality of divided display regions being assigned to the plurality of terminal devices, respectively, the process comprising:
receiving the plurality of images from the plurality of terminal devices, respectively;
determining to crop at least one of the plurality of images, upon detecting that some or all of the plurality of images including the at least one of the plurality of images have more than a predetermined number of parts in common;
cropping one of the plurality of images and generating a new image based on a cropped part of the one of the plurality of images, in response to a determination of the determiner to crop the one of the plurality of images; and
adjusting a size of the new image in accordance with a size of one of the plurality of divided display regions assigned to one of the plurality of terminal devices from which the one of the plurality of images is received and configured to display the new image having an adjusted size on the one of the plurality of divided display regions.
